(19) United States
(12) Patent Application Publication
(10) Pub. No.: US 2025/0237969 A1
(43) Pub. Date: Jul. 24, 2025

(54) RESIN, RESIN COMPOSITION, PRINTED IMAGE, ELECTROSTATIC CHARGE IMAGE DEVELOPING TONER, AND METHOD FOR PRODUCING ELECTROSTATIC CHARGE IMAGE DEVELOPING TONER

(71) Applicant: Konica Minolta, Inc., Tokyo (JP)

(72) Inventor: Kazuya ISOBE, Tokyo (JP)

(21) Appl. No.: 19/012,529

(22) Filed: Jan. 7, 2025

(30) Foreign Application Priority Data
Jan. 23, 2024 (JP) 2024-007990

(51) Int. Cl. G03G 9/087; C08F 212/08

(52) U.S. Cl. CPC G03G 9/08711; C08F 212/08

(57) ABSTRACT

A resin comprising a constitutional unit represented by the following general formula (1):

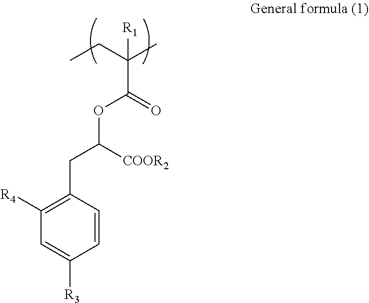

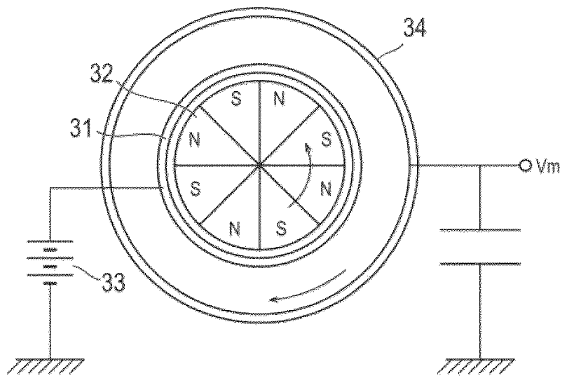

in the general formula (1), R1 represents a hydrogen atom or a methyl group, R2 represents a hydrogen atom or an alkyl group having 1 to 4 carbon atoms, and R3 and R4 each independently represent a hydrogen atom or an alkoxy group having 1 to 4 carbons.

### CROSS REFERENCE TO RELATED APPLICATIONS

The entire disclosure of Japanese Patent Application No. 2024-007990 filed on Jan. 23, 2024, is incorporated herein by reference in its entirety.

### BACKGROUND

### Technological Field

The present invention relates to a resin, a resin composition, a printed image, an toner for developing an electrostatic image (herein simply referred to as “electrostatic charge image developing toner”), and a method for producing an electrostatic charge image developing toner. In particular, the present invention relates to a biomass-derived resin and the like having excellent thermal characteristics and electrical characteristics.

### Description of Related Art

The production of industrially useful chemical products from inedible biomass is one of the technologies that can contribute to the realization of a low-carbon society. Biomass-derived chemical products that have been industrialized so far are mainly aliphatic materials, and the production of aromatic materials that impart functionality such as thermal stability and rigidity to polymers has not been realized.

Phenyllactic acids can be mentioned as one of aromatic materials that can be derived from cellulose, which is a non-edible biomass, with high productivity. This material can be used as a polyester material by polycondensation, but has not yet been put into practical use. When a phenyllactic acid can be derived into a (meth)acrylic ester and applied to addition polymerization as a monomer raw material, the target application of the obtained resin can be remarkably expanded without being limited to polycondensation, and the substitution for an aromatic polymer material derived from petroleum or the development of a new functional material can be expected. It is considered that these developments can greatly advance the creation of a low-carbon society.

Specifically, it is considered that the realization of a low-carbon society can be achieved by producing polymer materials using phenyllactic acids as described below.
(1) Finding a material having high possibility for practical use as a raw material for chemical products from among low-molecular phenyllactic acids produced from glucose.
(2) Deriving the above phenyllactic acids into industrially useful aromatic monomers.
(3) Producing polymer materials having desired performance from the aromatic monomers.

One application of resin materials is toner used for digital printing. As a main raw material of a conventional toner, styrene which is a petroleum-based material can be mentioned. Styrene is a hard segment having a relatively high glass transition temperature and constitutes a large amount of the resin for toner. An example of a biomass monomer that is considered to be able to substitute for the styrene used as the hard segment is bio-methyl methacrylate. While the use of biomass-derived raw materials can contribute to the realization of a carbon-free society without using petroleum resources, it has been difficult to satisfy both thermal and electrical characteristics required for resin materials for toner. Toner is fixed on a medium, such as paper, by heat, pressure, and the like and is output as an image. However, an amount of power consumed as heat at the time of fixing accounts for 70% of an amount of power consumed by the entire toner image forming apparatus. Therefore, in order to reduce power consumption in the formation of a toner image, a reduction in the amount of power consumption at the time of the thermal fixing of a toner has been a large continuing problem.

Conventionally, in response to such a challenge of reducing power consumption, development of a resin material that can be melted with a small amount of energy has been studied (see, for example, Japanese Unexamined Patent Publication No. 2007-279714, Japanese Unexamined Patent Publication No. 2008-287229, and Japanese Unexamined Patent Publication No. 2010-15159). Specifically, studies have been conducted on lowering the glass transition temperature of a resin and lowering the melt viscosity of a toner by controlling the molecular weight distribution of the resin.

The glass transition temperature of a resin can be adjusted by the ratio of monomers, for example, in the case of a styrene-acrylic-based resin. Specifically, it can be adjusted by the ratio of a monomer which becomes a hard segment (high glass transition temperature component) such as styrene and a monomer which becomes a soft segment (low glass transition temperature component) such as n-butyl acrylate.

However, increasing the proportion of the soft segment in the resin has a problem that, for example, when the resin is used as a toner, while low-temperature fixing of the toner can be achieved, the fixing separability of the toner deteriorates. In addition, n-butyl acrylate, which is commonly used as a monomer to form a soft segment, has a high dielectric loss tangent (tan 6), which is an index of charge leakage. Therefore, in a case of using n-butyl acrylate, there is also a problem that the charge retainability of the toner is lowered. The low charge retainability leads to a reduction in the amount of charge of the toner, and as a result, problems such as contamination inside the apparatus due to toner scattering and occurrence of image failure have become apparent.

In addition, a resin whose viscosity can be reduced with a low energy amount and which has low charge leakage properties is required in some cases, and a biomass-derived resin whose viscosity is more likely to be reduced at a low temperature and which has excellent charge retaining properties has been required.

### SUMMARY

The present invention has been made in consideration of the above-mentioned problems and situations. The present invention provides a biomass-derived resin excellent in thermal characteristics and electrical characteristics, as well as a resin composition using the resin, a printed image, an electrostatic charge image developing toner, and a method for producing the electrostatic charge image developing toner.

In order to achieve at least one of the aforementioned objects, a resin includes a constitutional unit represented by the following general formula (1).

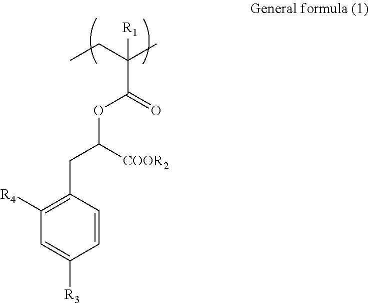

In the general formula (1), R₁ represents a hydrogen atom or a methyl group. R₂ represents a hydrogen atom or an alkyl group having 1 to 4 carbon atoms. R₃ and R₄ each independently represent a hydrogen atom or an alkoxy group having 1 to 4 carbons.

### BRIEF DESCRIPTION OF DRAWINGS

The advantageous and features provided by one or more embodiments of the invention will become more fully understood from the detailed description given hereinbelow and the appended drawing which are given by way of illustration only, and thus are not intended as a definition of the limits of the present invention:

The FIGURE illustrates an apparatus for measuring a charge amount used in Examples.

### DETAILED DESCRIPTION OF EMBODIMENTS

Hereinafter, one or more embodiments of the present invention will be described with reference to the drawing. However, the scope of the invention is not limited to the disclosed embodiments.

The resin according to the present embodiment is characterized by having the constitutional unit represented by the above general formula (1). This feature is a technical feature common to or corresponding to the following embodiments.

In the resin according to the present embodiment, it is preferable that R₂ in the general formula (1) is a methyl group and R₃ and R₄ each are a hydrogen atom. Thus, the thermal characteristics and the electrical characteristics become more satisfactory. The stereoregularity of the lactic acid moiety may be any of D-form, L-form and a mixture of D-form and L-form.

The resin according to the present embodiment is preferably a copolymer of a first polymerizable monomer having a structure represented by the following general formula (2) and a second polymerizable monomer copolymerizable with the first polymerizable monomer. As a result, the effect of the present invention can be exhibited more efficiently.

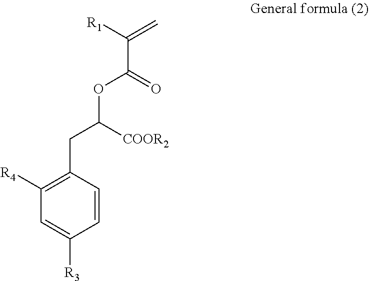

In the resin according to the present embodiment, the content of the constitutional unit derived from the first polymerizable monomer is preferably in the range of 10 to 40% by mass based on the total constitutional units (100% by mass) constituting the resin. Thus, the thermal characteristics and the electrical characteristic become more satisfactory.

In an embodiment of the resin according to the present embodiment, the second polymerizable monomer preferably includes at least one monomer selected from the group consisting of styrenes, acrylic acid, methacrylic acid, acrylic acid esters, and methacrylic acid esters. This makes it easy to adjust the glass transition temperature of the resin.

In an embodiment of the polymer according to the present embodiment, the second polymerizable monomer preferably includes at least one monomer selected from the group consisting of styrene, acrylic acid, n-butyl acrylate, iso-butyl acrylate, 2-ethylhexyl acrylate, methacrylic acid, n-butyl methactylate, iso-butyl methacrylate, and 2-ethylhexyl methacrylate. This makes it easy to adjust the glass transition temperature of the resin.

A resin composition according to the present embodiment contains a resin having a constitutional unit represented by general formula (1).

A printed image according to the present embodiment contains a resin having a constitutional unit represented by the above general formula (1).

An electrostatic charge image developing toner according to the present embodiment contains a resin having a constitutional unit represented by general formula (1).

A method for producing the electrostatic charge image developing toner according to the present embodiment includes a step of preparing a resin including the constitutional unit represented by general formula (1), preparing a toner binder particle-dispersed liquid (dispersion liquid in which toner binder particles are dispersed), and aggregating the toner binder particles in the toner binder particle-dispersed liquid to fuse the particles to each other. Thus, a biomass-derived resin having excellent thermal characteristics and electrical characteristics can be produced.

In the method for producing an electrostatic charge image developing toner according to the present embodiment, the step of providing a resin including the constitutional unit represented by the general formula (1) may include a step of polymerizing the first polymerizable monomer having the structure represented by the general formula (2).

The present invention, its components, and modes and aspects for carrying out the present invention will be described below. In the present description, when two figures are used to indicate a range of value before and after “to”, these figures are included in the range as a lower limit value and an upper limit value.

### [1. Resin Having Constitutional Unit Represented by General Formula (1)]

The resin according to the present embodiment has a constitutional unit represented by the following general formula (1).

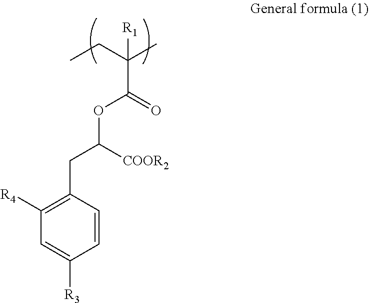

In the general formula (1), R₁ represents a hydrogen atom or a methyl group. R₂ represents a hydrogen atom or an alkyl group having 1 to 4 carbon atoms. R₃ and R₄ each independently represent a hydrogen atom or an alkoxy group having 1 to 4 carbons.

Specific examples of R₂ include hydrogen atom, methyl group, ethyl group, n-propyl group, iso-propyl group, n-butyl group, iso-butyl group, and t-butyl group.

Specific examples of R₃ and R₄ include hydrogen atom, methoxy group, ethoxy group, n-propoxy group, iso-propoxy group, n-butoxy group, iso-butoxy group, and t-butoxy group.

R₂ is preferably an alkyl group having 1 to 4 carbon atoms, from the viewpoint of lowering the hydrogen bonding properties, moderately suppressing the interaction between molecular chains and becoming easy to lower the viscosity at a relatively low temperature. From the viewpoint of reducing the influence of alkyl groups having relatively low polarity, increasing the polarity of the resins, and reducing the charge leakage, in addition to reducing the viscosity, a methyl group is more preferred as R₂. Similarly, from the viewpoint of thermal characteristics and electrical characteristics, R₃ and R₄ are each preferably a hydrogen atom.

The resin having a constitutional unit represented by general formula (1) can be synthesized by polymerizing a first polymerizable monomer having a structure represented by the following general formula (2).

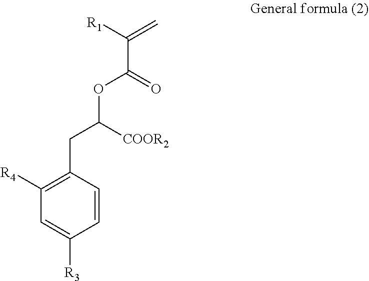

In general formula (2), R₁ represents a hydrogen atom or a methyl group. R₂ represents a hydrogen atom or an alkyl group having 1 to 4 carbon atoms. R₃ and R₄ each independently represent a hydrogen atom or an alkoxy group having 1 to 4 carbons.

R₂, R₃ and R₄ in general formula (2) have the same definitions as R₂, R₃ and R₄ in general formula (1), respectively.

The first polymerizable monomer may be used alone or in combination of two or more types thereof.

Specific examples of the first polymerizable monomer include the following exemplary compounds M1 to M7. Note that the first polymerizable monomer is not limited thereto.

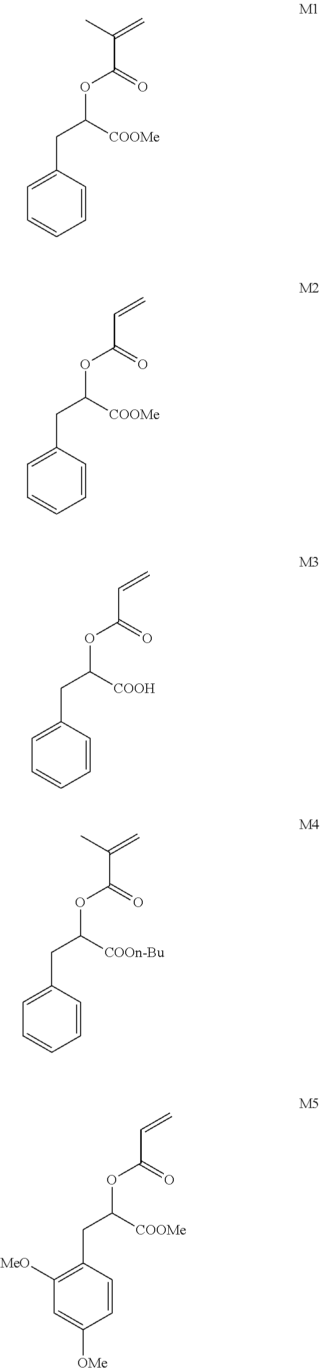

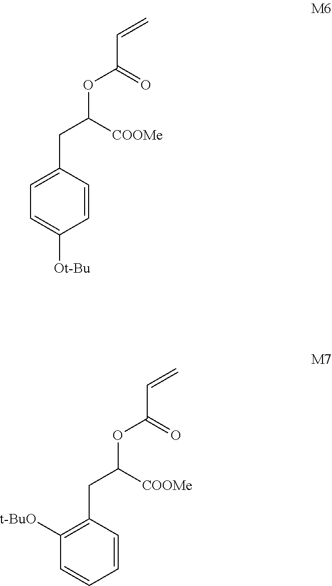 [SMILES: C=CC(=O)OC(Cc1ccc(OC(C)(C)C)cc1)C(=O)OC ; C=CC(=O)OC(Cc1ccccc1OC(C)(C)C)C(=O)OC]

The first polymerizable monomer can be synthesized, for example, by the following synthesis scheme.

### Synthesis of Phenyl Lactates

In a four-neck flask, phenyllactic acid 275 mmol was dissolved in dry THF 405 ml, triethylamine 560 mmol was added thereto, and then (meth)acryloyl chloride 280 mmol was added dropwise over 30 min at 0° C. After the completion of the dropwise addition, the mixture was stirred for 1 hr at room temperature. The mixture was extracted three times with ethyl acetate, and the organic layer was washed with water and dried with MgSO₄. The solvent was distilled off, and the obtained compound was purified by silica gel chromatography using a hexane/ethyl acetate solvent.

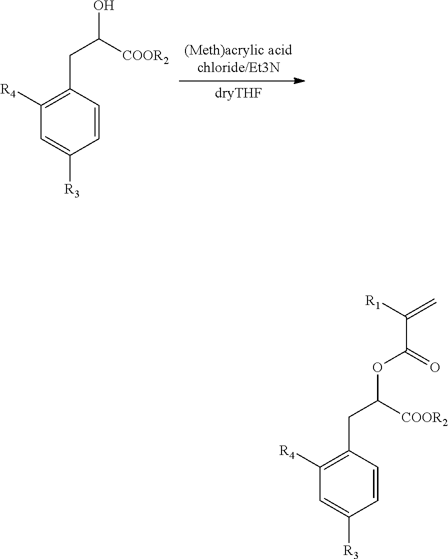

The resin according to the present embodiment may be a polymer obtained from only the first polymerizable monomer having the structure represented by the general formula (2). However, from the viewpoint of more efficiently exhibiting the effect of the present invention, it is preferable that the resin is a copolymer of a first polymerizable monomer having a structure represented by the general formula (2) and another polymerizable monomer copolymerizable with the first polymerizable monomer (also referred to as a “second polymerizable monomer”).

Examples of the second polymerizable monomer include the following:
styrenes such as styrene, α-methylstyrene, o-methylstyrene, m-methylstyrene, p-methylstyrene, o-ethylstyrene, m-ethylstyrene, p-ethylstyrene, o-acetoxystyrene, m-acetoxystyrene, and p-acetoxystyrene;
acrylic acid esters such as methyl acrylate, ethyl acrylate, isopropyl acrylate, n-butyl acrylate, tert-butyl acrylate, isobutyl acrylate (iso-butyl acrylate), n-octyl acrylate, 2-ethylhexyl acrylate, stearyl acrylate, lauryl acrylate, phenyl acrylate, dimethylaminoethyl acrylate, and diethylaminoethyl acrylate;
methacrylic acid esters such as methyl methacrylate, ethyl methacrylate, n-butyl methacrylate, isopropyl methacrylate, isobutyl methacrylate (iso-butyl methacrylate), tert-butyl methacrylate, n-octyl methacrylate, 2-ethylhexyl methacrylate, stearyl methacrylate, lauryl methacrylate, phenyl methacrylate, dimethylaminoethyl methacrylate, and diethylaminoethyl methacrylate; and
acrylic acid, methacrylic acid, and the like.

Of these, the second polymerizable monomer preferably includes at least one monomer selected from the group consisting of styrenes, acrylic acid, methacrylic acid, acrylic acid esters, and methacrylic acid esters. In addition, it is preferable to select one or more from styrene, acrylic acid, n-butyl acrylate, iso-butyl acrylate, 2-ethylhexyl acrylate, methacrylic acid, n-butyl methacrylate, iso-butyl methacrylate, and 2-ethylhexyl methacrylate. Furthermore, at least one of styrene and n-butyl acrylate is more preferable. Use of such a polymerizable monomer facilitates adjustment of the glass transition temperature of the resin.

As the second polymerizable monomer, a polymerizable monomer having an ionic dissociable group may be used. The polymerizable monomer having an ionic dissociable group is a monomer having, for example, a group such as a carboxy group, a sulfonic acid group, or a phosphate group. Specific examples thereof include acrylic acid, methacrylic acid, maleic acid, itaconic acid, and fumaric acid. Among these, acrylic acid or methacrylic acid is preferable.

The second polymerizable monomer may be used alone or in combination of two or more types thereof.

In the resin according to the present embodiment, the content of the constitutional unit derived from the first polymerizable monomer is preferably in the range of 5 to 50% by mass, more preferably in the range of 10 to 40% by mass, and still more preferably in the range of 15 to 35% by mass, based on the total constitutional units (100% by mass) constituting the resin. When the content of the constitutional unit derived from the first polymerizable monomer is increased, the chargeability is easily increased. In addition, when the content of the constitutional unit derived from the first polymerizable monomer is 10 to 40% by mass, a bulky constitutional unit is appropriately introduced, and thus the low melt viscosity is easily achieved, and in the case of being used for a toner, the low temperature fixability is easily enhanced. In addition, when the content of the constitutional unit derived from the first polymerizable monomer is from 15 to 35% by mass, the melt viscosity is further easily lowered, and in the case of use in a toner, the low-temperature fixability is further easily enhanced.

In the resin according to the present embodiment, the content of the constitutional unit derived from the second polymerizable monomer is not particularly limited, and can be appropriately adjusted according to the type of the constitutional unit.

For example, when the second polymerizable monomer includes styrenes, the content of the styrenes is preferably in the range of 20 to 80% by mass and more preferably in the range of 30 to 70% by mass based on the total constitutional units (100% by mass) constituting the resin.

When the second polymerizable monomer includes an acrylic acid ester or a methacrylic acid ester, the content of the acrylic acid ester or the methacrylic acid ester is preferably in the range of 5 to 50% by mass, and more preferably in the range of 10 to 40% by mass, based on the total constitutional units (100% by mass) constituting the resin.

In the case where the second polymerizable monomer includes a polymerizable monomer having an ionic dissociable group, such as acrylic acid and methacrylic acid, the content of the polymerizable monomer having an ionic dissociable group is preferably in the range of 2 to 8% by mass based on the total constitutional units (100% by mass) constituting the resin.

A method of synthesizing the resin according to the present embodiment using the first polymerizable monomer and optionally the second polymerizable monomer is not particularly limited. However, from the viewpoint of easy polymerization, a method of radically polymerizing a monomer using a known oil-soluble or water-soluble radical polymerization initiator is preferred.

Specific examples of the oil-soluble polymerization initiator to be used in the radical polymerization include azo- or diazo-based polymerization initiators and peroxide-based polymerization initiators described below. If necessary, for example, a known chain transfer agent such as n-octyl mercaptan or n-octyl-3-mercaptopropionate may be used.

Examples of the polymerization initiator include the following:
azo-based or diazo-based polymerization initiators such as 2,2′-azobis-(2,4-dimethyl valeronitrile), 2,2′-azobisisobutyronitrile, 1,1′-azobis (cyclohexane-1-carbonitrile), 2,2′-azobis-4-methoxy-2,4-dimethyl valeronitrile, azobisisobutyronitrile, and the like; and
peroxide-based polymerization initiators such as benzoyl peroxide, methyl ethyl ketone peroxide, diisopropylperoxycarbonate, cumenehydroperoxide, t-butylhydroperoxide, di-t-butylperoxide, dicumyl peroxide, 2,4-dichlorobenzoyl peroxide, lauroyl peroxide, 2,2-bis-(4,4-t-butylperoxycyclohexyl) propane, tris-(t-butylperoxy) triazin, and the like.

In addition, a water-soluble radical polymerization initiator can be used in a case where the resin is synthesized by an emulsion polymerization method.

Examples of the water-soluble radical polymerization initiator include persulfates such as potassium persulfate and ammonium persulfate, azobisaminodipropane acetate, azobiscyanovaleric acid and salts thereof, and hydrogen peroxide.

The polymerization temperature varies depending on the types of the monomers and the polymerization initiator to be used, but is preferably in the range of 50 to 100° C., more preferably in the range of 55 to 90° C.

The polymerization time varies depending on the types of the monomers and the polymerization initiator to be used, but is preferably, for example, 1 to 12 hours.

The resin according to the present embodiment preferably has a peak molecular weight, which is obtained from a molecular weight distribution in terms of polystyrene measured by gel permeation chromatography (GPC), in the range of 3500 to 35000. More preferably, it is within a range of 10000 to 30000. When the peak molecular weight is in such a range, the melt viscosity at the time of heating can be made to be in an appropriate range, and the handleability of the molten resin can be easily enhanced. For example, when the resin is used as a toner binder, the melt viscosity of the resin at the time of fixing becomes appropriate, and both good fixability and fixing separability can be achieved.

The peak molecular weight is a molecular weight corresponding to the elution time of the peak top in the molecular weight distribution. When a plurality of peaks are present in the molecular weight distribution, the molecular weight corresponding to the elution time of the peak top having the largest peak area ratio is defined as the peak molecular weight.

The peak molecular weight of the resin can be measured by the following method. To be specific, an apparatus “HLC-8220” (manufactured by Tosoh Corporation) and a column “TSKguardcolumn+TSKgelSuperHZM-M3 series” (manufactured by Tosoh Corporation) are used. Next, while the column temperature is maintained at 40° C., tetrahydrofuran (THF) as a carrier-solvent is allowed to flow at a flow rate of 0.2 ml/min. A measurement sample is dissolved in tetrahydrofuran so as to have a concentration of 1 mg/ml at room temperature (25° C.) under a dissolution condition in which treatment is performed for 5 minutes using an ultrasonic disperser. The measurement sample dissolved in THF is treated with a membrane filter having a pore size of 0.2 μm to obtain a sample solution. This sample solution (10 μL) is injected into the apparatus together with the above-mentioned carrier solvent, and the molecular weight distribution of the measurement sample is measured from a calibration curve prepared from a plurality of standard polystyrene samples using a refractive index detector (RI detector). The peak molecular weight is determined from the molecular weight distribution.

### [2. Resin Composition]

A resin composition according to the present embodiment contains a resin having a constitutional unit represented by general formula (1). The term “resin composition” refers to a composition containing two or more components including the resin.

Examples of the resin composition include a resin dispersion liquid, a resin solution, and a mixed resin.

Examples of the component other than the resin having the constitutional unit represented by general formula (1) contained in the resin composition according to the present embodiment include a resin not including the constitutional unit represented by general formula (1), a solvent, a dispersant, an antioxidant, a coloring material, an antifoaming agent, and a surfactant.

The resin composition according to the present embodiment can be used for resin molded articles and the like. Since the resin molded article according to the present embodiment is formed using the resin composition, the resin molded article is easily molded with low energy and has low charge leakage properties.

The melt flow rate (MFR) of the resin composition according to the present embodiment at 120° C. under a load of 2.16 kg is preferably 0.01 to 200 g/10 min, more preferably 0.01 to 60 g/10 min, from the viewpoint of obtaining a thermoplastic resin composition having good moldability. When the MFR of the resin composition is within the above range, the resin composition is easily molded with low energy. Note that the MFR can be measured at 120° C. in accordance with JIS K 7210 (IS01133).

The resin composition according to the present embodiment preferably has a dielectric loss tangent of 0.001 to 0.01 in 100 kHz measured at 25° C. When the dielectric loss tangent of the resin composition is within the above range, the charge leakage properties tend to become low. The dielectric loss tangent of the resin composition can be determined by an S-parameter method such as a capacitance method, a free space S-Para method or a corrugated circular waveguide S-Para method, or a cavity resonance method such as a balanced disc resonator method, a Fabry-Perot open resonator method, a split cylinder cavity resonator method, a split post dielectric resonator method, a cylindrical cavity resonator perturbation method or a blocked cylindrical waveguide method, but from the viewpoint of easiness of measurement, a value determined by the capacitance method is used in the present invention.

The resin molded article according to the present embodiment is obtained by melting and molding the resin composition in various molding machines. The molding method can be appropriately selected depending on the form and use of the molded article, and examples thereof include injection molding, extrusion molding, compression molding, blow molding, calender molding, and inflation molding. Further, a sheet-shaped or film-shaped molded article obtained by extrusion molding, calender molding, or the like may be subjected to secondary molding such as vacuum forming or pressure forming.

The use of the resin-molded article according to the present embodiment is not particularly limited, and examples thereof include components in the field of household appliances, automobiles, and the like (such as electrical components, exterior components, interior parts and the like); various packaging materials; household product; office supplies; piping and agricultural materials.

### [3. Electrostatic Charge Image Developing Toner]

An electrostatic charge image developing toner according to (hereinafter simply referred to as “toner”) the present embodiment contains a resin having a constitutional unit represented by the above general formula (1).

In the present application, the term “toner” refers to an aggregate of toner particles. The “toner particle” may be composed of a toner base particle and an external additive. The “toner base particles” may be constituted by a toner binder, a release agent, a coloring agent, a charge control agent, and the like.

### <Toner Binder>

The toner according to the present embodiment contains the resin including the constitutional unit represented by general formula (1) as a toner binder constituting toner base particles.

The toner binder may contain a resin other than the above-described resin. As the other resin, a resin generally used as a toner binder constituting toner base particles can be used without limitation.

Specific examples thereof include an acrylic resin not including the constitutional unit represented by the general formula (1); a methacrylic resin not including the constitutional unit represented by the general formula (1), polyester resin, silicone resin, polyolefin resin, polyamide resin and epoxy resin. These other resins may be used alone or in combination of two or more types thereof.

The polyester resin is a resin obtained by a polycondensation reaction between a carboxylic acid having a valency of two or more (polyvalent carboxylic acid component) and an alcohol having a valency of two or more (polyhydric alcohol component). The polyester resin may be amorphous or crystalline.

The valences of the polyvalent carboxylic acid component and the polyhydric alcohol component are each preferably 2 to 3, and particularly preferably 2. Therefore, as a particularly preferable embodiment, a case where each of the valences is 2 (that is, the dicarboxylic acid component and the diol component) will be described.

Examples of the dicarboxylic acid component include the following:
saturated aliphatic dicarboxylic acids such as oxalic, malonic, succinic, glutaric, adipic, pimelic, suberic, azelaic, sebacic, 1,9-nonanedicarboxylic, 1,10-decanedicarboxylic (dodecanedioic), 1,11-undecanedicarboxylic, 1,12-dodecanedicarboxylic, 1,13-tridecanedicarboxylic, 1,14-tetradecanedicarboxylic, 1,16-hexadecanedicarboxylic, and 1,18-octadecanedicarboxylic acids;
unsaturated aliphatic dicarboxylic acids such as methylenesuccinic, fumaric, maleicacid, 3-hexenedioicacid, 3-octenedioicacid, and dodecenylsuccinic acids; and
unsaturated aromatic dicarboxylic acids such as phthalic, terephthalic, isophthalic, t-butylisophthalic, tetrachlorophthalic, chlorophthalic, nitrophthalic, p-phenylenediacetic, 2,6-naphthalenedicarboxylic, 4,4′-biphenyldicarboxylic, anthracenedicarboxylic acids.

In addition, lower alkyl esters and acid anhydrides thereof can also be used. The dicarboxylic acid components may be used alone or in combination of two or more types thereof.

In addition, trivalent or higher polyvalent carboxylic acids such as trimellitic acid and pyromellitic acid, anhydrides of the carboxylic acid compounds, alkyl esters having 1 to 3 carbon atoms, and the like can also be used.

Examples of the diol component include the following:
saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, and neopentyl glycol;
unsaturated aliphatic diols such as 2-butene-1,4-diol, 3-butene-1,4-diol, 2-butyne-1,4-diol, 3-butyne-1,4-diol, 9-octadecene-7,12-diol and the like; and
aromatic diols, for example, bisphenols such as bisphenol A and bisphenol F, and alkylene oxide adducts of bisphenols, such as ethylene oxide adducts and propylene oxide adducts of these bisphenols.

In addition, derivatives thereof can also be used. The diol components may be used alone or in combination of two or more types thereof.

A method for producing the polyester resin is not particularly limited. The polyester resin can be produced by polycondensation (esterification) of a polyvalent carboxylic acid component and a polyhydric alcohol component using a known esterification catalyst.

Examples of the catalyst that can be used in the production of the polyester resin include the following: alkali metal compounds such as sodium and lithium;
compounds containing a Group 2 element such as magnesium or calcium;
compounds of metals such as aluminum, zinc, manganese, antimony, titanium, tin, zirconium, germanium; phosphorous acid compounds; phosphoric acid compounds; and amine compounds.

Specifically, examples of the tin compound may include dibutyltin oxide, tin octylate, tin dioctylate, and salts thereof.

Examples of the titanium compound include the following:
titanium alkoxides such as tetra-normal-butyl titanate (Ti (O-n-Bu)₄), tetraisopropyl titanate, tetramethyl titanate, tetrastearyl titanate and the like;
titanium acylates such as polyhydroxy titanium stearate; and titanium chelates such as titanium tetraacetylacetonate, titanium lactate, and titanium triethanolaminate.

Examples of the germanium compound include germanium dioxide and the like. Examples of the aluminum compound include polyaluminum hydroxide, aluminum alkoxide, and tributyl aluminate. These may be used alone or in combination of two or more types thereof.

The polymerization temperature is not particularly limited, but is preferably within a range of 70 to 250° C.

The polymerization time is also not particularly limited, but is preferably 0.5 to 10 hours. During the polymerization, the pressure in the reaction system may be reduced as necessary.

The polyester resin may be a hybrid polyester resin having a graft copolymer structure of a polyester polymerization segment and a styrene-acrylic polymerization segment graft.

The content of the resin including the constitutional unit represented by the general formula (1) in the toner binder is preferably in the range of 5 to 100% by mass, more preferably in the range of 5 to 50% by mass, and even more preferably in the range of 10 to 40% by mass, based on 100% by mass of the total mass of the toner binder.

### <Release Agent>

The toner base particles of the toner according to the present embodiment preferably contain a release agent. The release agent is preferably a fatty acid ester.

Examples of the fatty esters include, for example, behenyl behenate, stearyl stearate, behenyl stearate, stearyl behenate, butyl stearate, propyl oleate, hexadecyl palmitate, methyl lignocerate, glycerin monostearate (glyceryl stearate), diglyceryl distearate, pentaerythritol tetrabehenate, diethylene glycol monostearate, dipropylene glycol distearate, sorbitan monostearate, cholesteryl stearate, trimethylolpropane tribehenate, pentaerythritol diacetate dibehenate, glycerin tribehenate, tristearyl trimellitate, distearyl maleate, methyl triacontanate and the like. These fatty acid esters may be used alone or in combination of two or more types thereof.

As the fatty acid ester, commercially available products may be used, or synthesized products may be used.

In view of interaction with the resin according to the present embodiment, the fatty acid ester preferably includes a fatty acid ester having 16 to 24 carbon atoms. Examples of such fatty acids include stearic acid, arachidic acid, behenic acid, and lignoceric acid.

A more preferable release agent is at least one of behenyl behenate (the number of carbon atoms of the fatty acid ester is 22), pentaerythritol tetrabehenate (the number of carbon atoms of the fatty acid ester is 22), ethylene glycol distearate (the number of carbon atoms of the fatty acid ester is 18), methyl lignocerate (the number of carbon atoms of the fatty acid ester is 24), and hexadecyl palmitate (the number of carbon atoms of the fatty acid ester is 16). In particular, behenyl behenate (behenyl behenate), pentaerythritol tetrabehenate or ethylene glycol distearate is preferred.

The release agent may be a wax other than the fatty acid ester. Examples of waxes other than fatty acid esters include polyolefin waxes such as low-molecular-weight polyethylene and low-molecular-weight polypropylene, branched-chain hydrocarbon waxes such as microcrystalline wax, long-chain hydrocarbon waxes such as paraffin wax and Sasol wax, dialkyl ketone waxes such as distearyl ketone, and fatty acid amide waxes such as ethylenediamine behenylamide and trimellitic acid tristearylamide.

The content ratio of the release agent is preferably in the range of 1 to 25% by mass based on 100% by mass of the total mass of the resin including the constitutional unit represented by the general formula (1) from the viewpoint of the balance between the fixability and the offset resistance. More preferably, it is within a range of 5 to 20% by mass.

### <Coloring Agent>

In the toner according to the present embodiment, the toner base particles may contain a coloring agent. As the coloring agent, generally known dyes and pigments can be used.

Examples of a coloring agent for obtaining a black toner include carbon black, a magnetic material, and iron-titanium composite oxide black. Examples of the carbon black include channel black, furnace black, acetylene black, thermal black, and lamp black. In addition, examples of the magnetic material include ferrite and magnetic.

Examples of a coloring agent for obtaining a yellow toner include dyes such as C. I. Solvent Yellow 19, 44, 77, 79, 81, 82, 93, 98, 103, 104, 112, and 162; and pigments such as C. I. Pigment Yellow 14, 17, 74, 93, 94, 138, 155, 180, and 185.

Examples of a coloring agent for obtaining a magenta toner include dyes such as C. I. Solvent Red 1, 49, 52, 58, 63, 111, and 122; and pigments such as C. I. Pigment Red 5, 48:1, 53:1, 57:1, 122, 139, 144, 149, 166, 177, 178, and 222.

Examples of a coloring agent for obtaining a cyan toner include dyes such as C. I. Solvent Blue 25, 36, 60, 70, 93, and 95; and pigments such as C. I. Pigment Blue 1, 7, 15, 60, 62, 66, and 76.

The coloring agent for obtaining the toner of each color may be used alone or in combination of two or more types thereof for each color.

The content ratio of the coloring agent is preferably in a range of 0.5 to 20% by mass, and more preferably in a range of 2 to 10% by mass, based on 100% by mass of the total mass of the toner base particles.

### <Charge Control Agent>

In the toner according to the present embodiment, the toner base particles may contain a charge control agent.

The charge control agent to be used is not particularly limited as long as it is a substance capable of imparting a positive or negative charge by frictional charging and is colorless. Therefore, various known positively chargeable charge control agents and negatively chargeable charge control agents can be used as the charge control agent.

Specific examples of positively chargeable charge control agents include nigrosine dyes such as “Nigrosine Base EX” (manufactured by Orient Chemical Industries Co., Ltd), quaternary ammonium salts such as “Quaternary Ammonium Salts P-51” (manufactured by Orient Chemical Industries Co., Ltd) and “Copycharge PX VP435” (manufactured by Hoechst AG), alkoxylated amines, alkyl amides, molybdate chelate pigments, and imidazole compounds such as “PLZ1001” (manufactured by Shikoku Chemicals Corporation).

An example of a negatively chargeable charge control agent is “Bontron (registered trademark) S-22”, “Bontron (registered trademark) S-34”, “Bontron (registered trademark) E-81”, “Bontron (registered trademark) E-84” manufactured by Orient Chemical Industries Co., Ltd, metal complexes such as “SPIRON BLACK TRH” (manufactured by Hodogaya Chemical Co., Ltd), thioindigo-based pigment, quaternary ammonium salts such as “COPYCHARGE NX VP434” (manufactured by Hoechst Japan Ltd), a calixarene compound such as “BONTRON (registered trademark) E-89” (manufactured by Orient Chemical Industries Co., Ltd), boron compounds such as “LR147” (manufactured by JAPAN CARLIT CO., LTD), and fluorine compounds such as magnesium fluoride, carbon fluoride and the like.

As the metal complex used as the negatively chargeable charge control agent, in addition to those described above, the following having various structures can be used: an oxycarboxylic acid metal complex, a dicarboxylic acid metal complex, an amino acid metal complex, a diketone metal complex, a diamine metal complex, an azo group-containing benzene-benzene derivative skeleton metal complex, and an azo group-containing benzene-naphthalene derivative skeleton metal complex.

When the toner base particles contain the charge control agent, the chargeability of the toner is improved.

The content ratio of the charge control agent is preferably in the range of 0.01 to 30% by mass and more preferably in the range of 0.1 to 10% by mass based on 100% by mass of the total mass of the toner base particles.

### <Form of Toner Base Particles>

The form of the toner base particles is not particularly limited, and for example, forms such as a so-called single-layer structure, a core-shell structure, a multilayer structure of three or more layers, and a domain-matrix structure can be adopted. Note that the single-layer structure refers to a homogeneous structure that is not a core-shell type.

### <External Additives>

The toner according to the present embodiment may be configured by adding an external additive such as a fluidizing agent and/or a cleaning aid, namely post-treatment agents, to the toner base particles. Addition of such an external additive can improve the fluidity, chargeability, cleanability, and the like of the toner.

Examples of the external additive include inorganic particles such as silica particles, alumina particles, inorganic oxide particles such as titanium oxide particles, aluminum stearate particles, inorganic stearate compound particles such as zinc stearate particles, and inorganic titanate compound particles such as strontium titanate particles and zinc-titanate particles. These may be used alone or in combination of two or more types thereof.

These inorganic particles may be subjected to a surface treatment with a silane coupling agent, a titanium coupling agent, a higher fatty acid, silicone oil, or the like in order to improve heat-resistant storage properties and environmental stability.

The amount of the external additive to be added is preferably in a range of 0.05 to 5 parts by mass, and more preferably in a range of 0.1 to 3 parts by mass, relative to 100 parts by mass of the toner base particles.

### <Median Diameter of Toner Particles>

The volume-based median diameter (D50) of the toner particles is preferably in a range of 4 to 10 μm, and more preferably in a range of 5 to 9 μm. When the volume-based median diameter (D50) is within the above range, the transfer efficiency increases, the image quality of halftones improves, and the image quality of thin lines, dots, and the like improves.

In the present embodiment, the volume-based median diameter (D50) of the toner particles is measured and calculated by using a measuring device in which a computer system (manufactured by Beckman Coulter, Inc) equipped with data-processing software “Software V3.51” is connected to “Coulter Counter 3” (manufactured by Beckman Coulter, Inc.).

To be specific, 0.02 g of the measurement sample (toner) is added to and mixed with 20 mL of a surfactant solution. The surfactant solution is, for example, a surfactant solution obtained by diluting a neutral detergent containing a surfactant component with pure water by 10 times for the purpose of dispersing the toner particles.

Thereafter, ultrasonic dispersion is performed for 1 minute to prepare a toner dispersion liquid. This toner dispersion liquid is injected into a beaker containing “ISOTONII” (manufactured by Beckman Coulter, Inc) in a sample stand with a pipette until the display concentration of the measurement device becomes 8%.

Here, by setting the concentration in this range, a reproducible measurement value can be obtained. In the measurement device, the number of measured particle counts is set to 25000, the aperture diameter is set to 50 μm, and the frequency value is calculated by dividing the range of 1 to 30 μm, which is the measurement range, into 256 sections. Then, the particle size of 50% from the largest volume integrated fraction is defined as the volume-based median diameter (D50).

### [4. Method for Producing Toner]

A method for producing the toner is not particularly limited. For example, the toner can be produced by the following emulsion aggregation method. In addition, the toner can also be produced by melting and kneading the resin according to the present embodiment and, if necessary, a release agent, a coloring agent, and the like, and then performing pulverization, classification, and the like.

As the emulsion aggregation method, a method described in Japanese Unexamined Patent Publication No. H5-265252, Japanese Unexamined Patent Publication No. H6-329947, Japanese Unexamined Patent Publication No.

H9-15904 or the like can be employed. Furthermore, a production method using a suspension polymerization method described in Japanese Unexamined Patent Publication No. 2010-191043 may be used. Among these, a production method using an emulsion aggregation method is preferable from the viewpoint that the particle size and shape can be easily controlled and the energy cost at the time of production can be reduced.

The production method using such an emulsion aggregation method preferably includes the following steps.
(1A) A toner binder particle-dispersed liquid preparation step for preparing a dispersion liquid of toner binder particles
(1B) A coloring agent particle-dispersed liquid preparation step for preparing a dispersion liquid of coloring agent particles
(1C) A release agent particle-dispersed liquid preparation step for preparing a dispersion liquid of release agent particles
(2) An association step for forming associated particles in which an aggregating agent is added to an aqueous medium containing toner binder particles, coloring agent particles, and release agent particles, and salting out is promoted while simultaneously aggregation and fusing are performed
(3) An aging step for forming toner base particles by controlling shapes of the associated particles
(4) Filtration and washing step for filtering out the toner base particles from the aqueous medium and removing the surfactant and the like from the toner base particles
(5) A drying step of drying the washed toner base particles
(6) An external additive addition step for adding an external additive to the dried toner base particles

Hereinafter, the steps of (1A) to (1C) will be described.

### (1A) Toner Binder Particle-Dispersed Liquid Preparation Step

In this step, resin particles are formed by conventionally known emulsion polymerization or the like, and the resin particles are aggregated and fused to form toner binder particles. For example, polymerizable monomers (the first polymerizable monomer and the second polymerizable monomer) constituting the toner binder are charged and dispersed in an aqueous medium, and these polymerizable monomers are polymerized by a polymerization initiator. Thus, a dispersion liquid of toner binder particles is prepared.

In addition, as a method of obtaining the toner binder particle-dispersed liquid, there are the following methods in addition to the above-described method of polymerizing a polymerizable monomer with a polymerization initiator in an aqueous medium. For example, there is a method of performing a dispersion treatment in an aqueous medium without using a solvent. Alternatively, he following method is possible: a polymer is dissolved in an organic solvent such as ethyl acetate to prepare a solution, the solution is emulsified and dispersed in an aqueous medium using a dispersing machine, and then the solvent is removed.

At this time, if necessary, a release agent may be contained in the toner binder in advance. Furthermore, for dispersion, it is also preferable to perform polymerization in the presence of an appropriate known surfactant. Examples of the known surfactants include anionic surfactants such as sodium polyoxyethylene (2) dodecyl ether sulfate, sodium dodecyl sulfate, and sodium dodecylbenzenesulfonate.

The volume-based median diameter of the toner binder particles in the dispersion liquid is preferably within a range of 50 to 300 nm. The median diameter can be measured by a dynamic light scattering method using “Microtrac UPA-150” (manufactured by Nikkiso Co., Ltd).

### (1B) Coloring Agent Particle-Dispersed Liquid Preparation Step

The coloring agent particle-dispersed liquid preparation step is a process of dispersing a coloring agent in the form of fine particles in an aqueous medium to prepare a dispersion of coloring agent particles. The coloring agent can be dispersed by utilizing mechanical energy. The volume-based median diameter of the coloring agent particles in the dispersion liquid is preferably in a range of 10 to 300 nm, and more preferably in a range of 50 to 200 nm.

The volume-based median diameter of the coloring agent particles in the dispersion liquid can be measured by a dynamic light scattering method using “Microtrac UPA-150” (manufactured by Nikkiso Co., Ltd) in the same manner as described above.

### (1C) Release Agent Particle-Dispersed Liquid Preparation Step

The release agent particle dispersion preparation step is a step of preparing a dispersion of release agent particles by dispersing a release agent in the form of fine particles in an aqueous medium. The release agent can be dispersed by utilizing mechanical energy. The volume-based median diameter of the release agent particles in the dispersion liquid is preferably in a range of 100 to 1000 nm, and more preferably in a range of 200 to 700 nm. The volume-based median diameter of the release agent particles in the dispersion liquid can be measured by, for example, a laser diffraction particle size distribution analyzer LA-750 (manufactured by Horiba, Ltd).

### (Aqueous Medium)

Examples of the aqueous medium used in steps (1A) to (1C) include water, aqueous media containing water as the main component (50% by mass or more) and water-soluble solvents such as alcohols and glycols, and aqueous media containing optional components such as surfactants and dispersants. As the aqueous medium, a mixture of water and a surfactant is preferably used.

Examples of the water-soluble solvent include methanol, ethanol, isopropanol, butanol, acetone, methyl ethyl ketone, and tetrahydrofuran. Of these, alcohols such as methanol, ethanol, isopropanol and butanol, which are organic solvents that do not dissolve the polymer, are preferred.

Examples of the surfactant include cationic surfactants, anionic surfactants, and nonionic surfactants. Examples of the cationic surfactants include dodecylammonium chloride, dodecylammonium bromide, dodecyltrimethylammonium bromide, dodecylpyridinium chloride, dodecylpyridinium bromide, and hexadecyltrimethylammonium bromide. Examples of the anionic surfactants include fatty acid soaps such as sodium stearate and sodium dodecanoate, sodium dodecylbenzenesulfonate, and sodium dodecyl sulfate. Furthermore, examples of the nonionic surfactants include polyoxyethylene dodecyl ether, polyoxyethylene hexadecyl ether, polyoxyethylene nonylphenyl ether, polyoxyethylene lauryl ether, polyoxyethylene sorbitan monooleate ether, and monodecanoyl sucrose.

Such surfactants may be used alone or in combination of two or more types thereof. Among the surfactants, preferably anionic surfactants are used, more preferably sodium dodecylbenzenesulfonate, sodium dodecylsulfate.

The amount of the surfactant to be added is preferably in a range of 0.01 to 10 parts by mass, and more preferably in a range of 0.04 to 2 parts by mass, relative to 100 parts by mass of the aqueous medium.

The steps from (2) the association step to (6) the external additive addition step can be carried out according to various conventionally known methods.

Note that the aggregating agent used in (2) the association step is not particularly limited, but an aggregating agent selected from metal salts is suitably used.

Examples of the metallic salts used as the aggregating agent include monovalent metal salts such as salts of alkali metals such as sodium, potassium, and lithium; divalent metal salts such as calcium, magnesium, manganese, and copper; and trivalent metal salts such as iron and aluminum.

Specific examples of the metal salts include sodium chloride, potassium chloride, lithium chloride, calcium chloride, magnesium chloride, zinc chloride, copper sulfate, magnesium sulfate, manganese sulfate, and polyaluminum chloride. Among these, it is particularly preferable to use a divalent or trivalent metal salt because aggregation can be advanced with a smaller amount. These may be used alone or in combination of two or more types thereof.

The usage amount of the aggregating agent is not particularly limited, but is preferably 2% by mass to 30% by mass relative to the solid content of the toner binder from the viewpoint of controllability of the particle diameter of the toner.

### [5. Developer]

The toner according to the present embodiment can be used alone as a one component developer, or can be mixed with carrier particles and used as a two component developer.

When the toner is used as a one component developer, the toner may be a magnetic toner containing a magnetic material or a non-magnetic toner containing no magnetic material. As the magnetic material, for example, magnetite, γ-hematite, various types of ferrite, or the like can be used.

As the carrier particles constituting the two component developer, magnetic particles made of a conventionally known material, for example, a metal such as iron, steel, nickel, cobalt, ferrite, or magnetite, or an alloy of such a metal and a metal such as aluminum or lead can be used.

As the carrier particles, coated carrier particles obtained by coating the surfaces of magnetic particles with a coating agent such as a resin, or so-called resin-dispersed carrier particles obtained by dispersing a magnetic powder in a binder resin are preferably used.

The resin for coating is not particularly limited, but for example, an olefin resin, a styrene resin, a styrene-acrylic resin, a silicone resin, a polyester resin, or a fluororesin is used.

The resin for forming the resin-dispersed carrier particles is not particularly limited, and known resins can be used. As such a resin, for example, an acrylic resin, a styrene-acrylic resin, a polyester resin, a fluororesin, a phenol resin, or the like can be used.

The volume-based median diameter of the carrier particles is preferably within a range of 20 to 100 μm, and more preferably within a range of 25 to 60 μm.

The volume-based median diameter of the carrier particles can be typically measured by a laser diffraction particle size distribution analyzer equipped with a wet disperser. Examples of the laser diffraction particle size distribution analyzer include “HELOS” (manufactured by SYMPATEC GmbH).

The amount of the toner particles to be mixed to the carrier particles is preferably in a range of 2 to 10% by mass when the total mass of the toner particles and the carrier particles is 100% by mass.

### [6. Image Forming Method Using Toner]

The toner according to the present embodiment can be suitably used for an image forming method including a fixing step by a heat and pressure fixing system in which heating can be performed while pressure is applied. In particular, the toner can be suitably used in an image forming method in which fixing is performed at a relatively low fixing temperature in the fixing step. The fixing temperature is a temperature at which the surface temperature of the heating member at a fixing nip part, which is within a range of 115 to 140° C., and preferably 115 to 130° C.

The toner according to the present embodiment can also be suitably used in a high-speed fixing image forming method in which the fixing linear velocity is in a range of 200 to 600 mm/sec.

In the image forming method including the fixing step using the heat and pressure fixing system, for example, first, an electrostatic charge image formed on a photoreceptor is developed with a toner to obtain a toner image. The toner image is transferred from the photoreceptor to an image support. Thereafter, the toner image transferred onto the image support is fixed on the image support by fixing processing of a heat and pressure fixing system. Thus, a printed product on which a visible image is formed is obtained.

The toner according to the present embodiment can be used for a monochrome image forming method and a full-color image forming method. The present invention can be applied to a full-color image forming method of a four cycle system constituted by four types of color developing devices for yellow, magenta, cyan and black, respectively, and one photosensitive member. The present invention can also be applied to a tandem-type image forming method in which image forming units each having a color developing device and a photoreceptor for a individual color are mounted for the corresponding color. The toner according to the present embodiment may be applied to any of the image forming methods described above.

### [7. Ink]

The resin of the present embodiment having the constitutional unit represented by general formula (1) can also be contained in an ink. The ink may contain, in addition to the resin according to the present embodiment, a coloring material, a solvent, other resins, various additives, and the like.

An ink containing the resin according to the present embodiment can form an image excellent in lightfastness and adhesion to a medium.

Since the resin according to the present embodiment has an aromatic ring, it has high ultraviolet absorptivity. Therefore, in an image formed using an ink containing the resin, the resin absorbs ultraviolet rays, and thus the coloring material is less likely to be affected by ultraviolet rays. Due to such an action, an image formed using an ink containing the resin according to the present embodiment has satisfactory lightfastness.

In addition, since the resin according to the present embodiment has a polar group, an image formed using an ink containing the resin according to the present embodiment has satisfactory adhesiveness to a medium such as paper.

Examples of a method of applying ink in image formation using ink include a spray method, a mangle method (a pad method or a dipping method), a coating method, and an ink jet method. In the case of forming a high-precision image, an inkjet method is preferred.

### [8. Printed Image]

A printed image according to the present embodiment is characterized by containing a resin having the constitutional unit represented by the above general formula (1).

The printed image can be formed using the above-described toner or ink.

The printed image is excellent in lightfastness and adhesion to a medium by containing the resin having the constitutional unit represented by the general formula (1).

### EXAMPLES

Hereinafter, the present invention will be specifically described with reference to Examples, but the present invention is not limited thereto. Note that in the following Examples, operations were performed at room temperature (25° C.) unless otherwise specified. Further, unless otherwise specified, “%” and “part (s)” mean “% by mass” and “part (s) by mass”, respectively.

### [Polymerizable Monomer]

The above-described exemplary compounds M1 to M7 were used as the first polymerizable monomers having a constitutional unit represented by general formula (2).

In addition, as a comparative compound, M8 having the following structure was used.

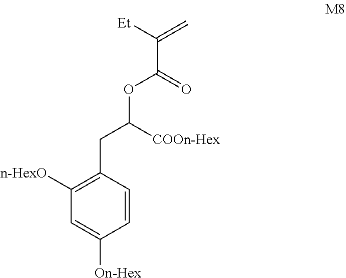

The R₁, R₂, R₃ and R₄ in the general formula (2) in M1 to 8 is as illustrated in the following table.

TABLE 1

| | R₁ | R₂ | R₃ | R₄ |
|---|---|---|---|---|
| M1 | Me | Me | H | H |
| M2 | H | Me | H | H |
| M3 | H | H | H | H |
| M4 | Me | n-Bu | H | H |
| M5 | H | Me | OMe | OMe |
| M6 | H | Me | H | o-t-Bu |
| M7 | H | Me | o-t-Bu | H |
| M8 | Et | n-Hex | o-n-Hex | o-n-Hex |

The abbreviations described in Table 1 represent the following atoms or substituents, respectively.
H: hydrogen atom
Me: methyl group
Et: ethyl group
n-Bu: n-butyl group
n-Hex: n-hexyl group
OMe: methoxy group
o-t-Bu: t-butoxy group
o-n-Hex: n-hexoxy group
As the second polymerizable monomer, the following compounds were used.
St: styrene
MMA: methyl methacrylate
nBA: n-butyl acrylate
iBA: iso-butyl acrylate
2EHA: 2-ethylhexyl acrylate
MAA: methacrylic acid
AA: acrylic acid

### [Synthesis of Resin]

A surfactant solution was prepared by dissolving sodium dodecyl sulfate 8 g in ion exchanged water 3 L. The surfactant solution was charged into a 5 L stainless steel kettle (SUS kettle) equipped with a stirrer, a temperature sensor, a cooling tube, and a nitrogen introduction device. Then, the mixture was heated to a liquid temperature of 80° C. while stirring at a stirring speed of 230 rpm under a nitrogen stream.

To this surfactant solution, an initiator solution prepared by dissolving potassium persulfate 10 g in ion-exchanged 200 g was added, and the temperature was adjusted to 80° C. Thereafter, each of mixed solutions was prepared by adding polymerizable monomers in an addition ratio shown in the following Table 2 so that the solid content concentration of the obtained resin particle-dispersed liquid became 20% by mass, and the mixed solution was added dropwise to the surfactant solution over 100 minutes. The system was heated and stirred at 80° C. for 2 hours to polymerize the polymerizable monomers.

The addition amounts of the polymerizable monomers described in Table 2 represents respective addition amounts when the total addition amount of the first and second polymerizable monomers is 100% by mass.

In this manner, resin particle-dispersed liquids 1 to 14 each having a solid content concentration of 20% by mass were prepared. The resins contained in the resin particle-dispersed liquids 1 to 14 are referred to as resins 1 to 14, respectively.

The peak molecular weights of the resins 1 to 14 are as listed in Table 2. The peak molecular weight was measured as follows. An apparatus “HLC-8220” (manufactured by Tosoh Corporation) and a column “TSKguardcolumn+TSKgelSuperHZM-M3 series” (manufactured by Tosoh Corporation) were used. While the column temperature was maintained at 40° C., tetrahydrofuran (THF) was allowed to flow as a carrier-solvent at a flow rate of 0.2 ml/min. Next, the measurement sample was dissolved in tetrahydrofuran so as to have a concentration of 1 mg/ml under a dissolution condition in which the measurement sample was treated for 5 minutes using an ultrasonic disperser at room temperature (25° C.). Then, the solution was treated with a membrane filter having a pore size of 0.2 μm to obtain a sample solution, and 10 μL of the sample solution was injected into the apparatus together with the above-mentioned carrier solvent. Then, the molecular weight distribution of the measurement sample was detected using a refractive index detector (RI detector). The peak molecular weight was determined from the molecular weight distribution.

The volume-based median diameters of the resin particles in the resin particle-dispersed liquids 1 to 14 were all 128 nm. The median diameter was measured by a dynamic light scattering method using “Microtrac UPA-150” (manufactured by Nikkiso Co., Ltd).

### [Preparation of Toner]

Toners were prepared as described below using the resin particle-dispersed liquids 1 to 14 as toner binder particle-dispersed liquids.

### <Preparation of Coloring Agent-Dispersed Liquid>

| Coloring agent: carbon black | 10 | parts by mass |
|---|---|---|
| (Mogul (registered trademark) L, | | |
| manufactured by Cabot Corporation) | | |
| Anionic surfactant | 1.5 | parts by mass |
| (sodium dodecylbenzenesulfonate | | |
| 20% aqueous solution) | | |
| Ion-exchanged water | 90 | parts by mass |

The above components were mixed and dispersed with an SC mill to obtain a coloring agent-dispersed liquid.

The volume-based median diameter of the coloring agent particles in the coloring agent-dispersed liquid was 154 nm. The median diameter was measured by a dynamic light scattering method using “Microtrac UPA-150” (manufactured by Nikkiso Co., Ltd).

### <Preparation of Release Agent-Dispersed Liquid>

| | |
|---|---|
| Behenyl behenate | 100 parts by mass |
| Sodium dodecyl sulfate | 5 parts by mass |
| Ion-exchanged water | 240 parts by mass |

The above components were dispersed in a round-shaped stainless-steel flask for 10 minutes using a homogenizer “Ultra-Turrax (registered trademark) T50” (manufactured by IKA). Thereafter, a dispersion treatment was performed with a pressure discharge type homogenizer to obtain a release agent-dispersed liquid.

The volume-based median diameter of the release agent particles in the release agent-dispersed liquid was 530 nm. The volume-based median diameter Wws measured with a laser diffraction particle size distribution analyzer LA-750 (manufactured by Horiba, Ltd).

### <Preparation of Toner Base Particle-Dispersed Liquid 1>

| | |
|---|---|
| Toner binder particle-dispersed liquid 1 | 237 parts by mass |
| Coloring agent-dispersed liquid | 42 parts by mass |
| Release agent-dispersed liquid | 18 parts by mass |
| Polyaluminum chloride | 1.8 parts by mass |
| Ion-exchanged water | 600 parts by mass |

The above components were mixed and dispersed in a round stainless-steel flask using a homogeniser “Ultra-Turrax (registered trademark) T50” (manufactured by IKA). Thereafter, the mixture in the flask was heated to 55° C. in a heating oil bath while being stirred. After holding at 55° C. for 30 minutes, it was confirmed that aggregated particles having a volume-based median diameter (D50) of 4.8 μm were formed in the liquid.

When the temperature of the heating oil bath was further raised and maintained at 56° C. for 2 hours, the volume-based median diameter (D50) became 5.9 μm.

Thereafter, 1 mol/L sodium hydroxide was added to the system to adjust the system pH to 5.0. Thereafter, the stainless steel flask was sealed with a magnetic seal, and heated to 98° C. while stirring was continued. The stirring was continued for 6 hours to complete fusion between the toner binder particles, thereby preparing a toner base particle-dispersed liquid. The volume-based median diameter (D50) of the toner base particles in the dispersion liquid was 6.0 μm.

### <Washing and Drying Step>

The toner base particle-dispersed liquid was subjected to solid-liquid separation with a basket-type centrifuge “MARKIII, model number 60×40” (manufactured by Matsumoto Kikai Co., Ltd) to form a wet-cake of toner base particles.

The wet cake was washed with ion-exchanged water at 45° C. by the basket type centrifugal separator until the electric conductivity of the filtrate became 5p S/cm. Thereafter, the resultant was transferred to “Flash Jet Dryer” (manufactured by Seishin Enterprise Co., Ltd) and dried until the moisture amount became 0.5% by mass, to obtain toner base particles 1.

### <Preparation of Toner Base Particles 2 to 14>

Toner base particles 2 to 14 were prepared in the same manner as in the preparation of the toner base particle 1, except that the toner binder particle-dispersed liquid 1 was changed to the corresponding one of the toner binder particle-dispersed liquids 2 to 14, respectively.

### <External Additive Treatment of Toner Base Particles>

To 100 parts by mass of the toner base particles obtained above, 1 part by weight of hydrophobic silica (number-average primary particle size=12 nm) and 0.3 parts by mass of hydrophobic titania (number-average primary particle size=20 nm) were added. Next, external additive treatment was performed by mixing with a Henschel mixer (registered trademark), thereby producing toners 1 to 14.

### [Preparation of Two Component Developer]

The following components are placed in a horizontal stirring blade-type high-speed stirring device and mixed for 15 minutes under the conditions of impeller peripheral speed of 8 m/s and temperature of 30° C.

| | |
|---|---|
| Ferrite particles (volume-based median diameter: | 100 parts by mass |
| 50 μm (manufactured by Powdertech Co., Ltd)) | |
| Methyl methacrylate-cyclohexyl methacrylate | 4 parts by mass |
| copolymer resin (volume-based median diameter | |
| of primary particles: 85 nm) | |

Next, the temperature of the system was raised to 120° C., and stirring was continued for 4 hours. Thereafter, the system was cooled, and fragments of the methyl methacrylate-cyclohexyl methacrylate copolymer resin were removed using a 200 mesh sieve. Thus, a resin-coated carrier was produced.

The resin-coated carrier was mixed with each of the toners 1 to 14 such that the concentration of the toner was 7% by mass with respect to the total mass of the toner and the carrier, thereby preparing two component developers 1 to 14.

TABLE 2

| amount | Second monomer addition amount (% by mass) | | | | | | |
|---|---|---|---|---|---|---|---|
| mass) | St | MMA | nBA | iBA | 2EHA | MAA | AA |
| [symbol] .0 | 46.5 | | 18.0 | 10.0 | | 5.5 | |
| .0 | 60.5 | | 14.5 | | 3.0 | | 2.0 |
| .0 | 55.0 | | 11.5 | 5.0 | 8.5 | | |
| .0 | 46.0 | | 7.5 | 19.0 | 2.0 | 5.5 | |
| .0 | 59.5 | | 17.0 | 12.5 | | 6.0 | |
| .0 | 67.0 | | 10.0 | | 11.0 | | 2.0 |
| .0 | 26.5 | | 8.0 | 15.0 | 5.0 | 5.5 | |
| .0 | 20.0 | | 24.5 | | | 5.5 | |
| .0 | 54.0 | | 12.5 | | 7.5 | 6.0 | |
| .0 | 53.5 | | 11.0 | 3.5 | 6.0 | 6.0 | |
| .0 | 60.0 | | 10.0 | 2.0 | 6.0 | | 2.0 |
| .0 | 54.5 | | 12.0 | | 9.0 | 4.5 | |
| .0 | 68.5 | | 26.0 | | | 5.5 | |
| .0 | 48.5 | 20.0 | 26.0 | | | 5.5 | |

[symbol]

indicates data missing or illegible when filed

### Evaluation

Using the two component developers 1 to 14, fixability and chargeability were evaluated as described below. The evaluation results are as listed in Table 3.

### (1) Fixability

As the image forming apparatus, a commercially available multifunction peripheral “bizhub PRO C65003” (manufactured by Konica Minolta Business Technologies Inc) was used. The apparatuses was loaded with the two component developer as a developer. Then the surface temperature of the fixing and heating member in the fixing means of the heat roll fixing system was changed in increments of 5° C. in the range of 80 to 150° C. For each temperature, image formation was performed under an environment of normal temperature and normal humidity (temperature of 20° C. and humidity of 50% RH) using thick paper having a basis weight of 350 g/m2 as the image support to obtain a solid image having an image density of 0.8 as a visible image. Thereafter, the fixed solid image was folded using a folding machine, and air of 0.35 MPa was blown thereto. The state of the fold was evaluated in five stages by the retention rate of the image density according to the following evaluation criteria, and the fixing temperature of rank 3 was defined as the lowest fixing temperature. When the lowest fixing temperature indicating the rank 3 level is 130° C. or less, sufficient low-temperature fixability is exhibited.

### [Evaluation Criterion]

Rank 5: image density retention rate is 90% or more
Rank 4: image density retention rate is 75% or more and less than 90
Rank 3: image density retention rate is 60% or more and less than 75%
Rank 2: image density retention rate is 45% or more and less than 60%
Rank 1: image density retention rate is less than 45%

### (2) Chargeability

The charge amount of the toner was measured using an apparatus illustrated in the FIGURE.

First, a developer 1 g weighed with a precision balance was placed on the entire surface of the conductive sleeve (31) so as to be uniform. A voltage of 2 kV was supplied from the bias power source (33) to the sleeve (31), and the number of rotations of the magnet roll (32) provided in the conductive sleeve (31) was set to 1000 rpm. This state was maintained for 30 seconds, and the toner was collected on the cylindrical electrode (34). After 30 seconds, the potential Vm of the cylindrical electrode (34) was read, and the charge amount of the toner was obtained. Furthermore, the mass of the collected toner was measured with a precision balance, and the average charge amount was determined. The value obtained by dividing the average charge amount by the mixing time (mixing for 10 minutes at a shaking angle of 300 and a shaking number of 200 strokes/min using a shaker (Yayoi type New-YS)) was used as the chargeability index.

When the chargeability index is 6.5p C/g/min or more, a sufficient charge amount without any problem is exhibited even at the time of high-speed print output.

TABLE 3

| | Evaluation rank | | |
|---|---|---|---|
| | Fixability | Chargeability | |
| | minimum fixing | charging index | |
| No | temperature (° C.) | (μC/g/min) | Remarks |
| 1 | 117 | 8.8 | Present invention |
| 2 | 116 | 8.7 | Present invention |
| 3 | 120 | 8.7 | Present invention |
| 4 | 119 | 7.7 | Present invention |
| 5 | 120 | 8.1 | Present invention |
| 6 | 119 | 8.3 | Present invention |
| 7 | 118 | 8.8 | Present invention |
| 8 | 121 | 8.9 | Present invention |
| 9 | 119 | 7.8 | Present invention |
| 10 | 117 | 7.9 | Present invention |
| 11 | 119 | 7.7 | Present invention |
| 12 | 121 | 5.9 | Comparative example |
| 13 | 120 | 5.7 | Comparative example |
| 14 | 132 | 6.4 | Comparative example |

From the above evaluation results, it is found that the toner containing the resin having the constitutional unit represented by general formula (1) has better fixability and chargeability than the toners of Comparative Examples.

Furthermore, from this, it is found that the resin having the constitutional unit represented by general formula (1) is excellent in thermal characteristics and electrical characteristics.

### INDUSTRIAL APPLICABILITY

According to the resin of the present invention, the viscosity can be reduced with a low energy amount, and the charge leakage property can be reduced. In addition, according to the electrostatic charge image developing toner of the present invention, low-temperature fixability can be sufficiently enhanced, and heat-resistant storage stability can be improved. Therefore, the present invention is useful in the field of image formation.

### REFERENCE SIGNS LIST

31 Conductive sleeve
32 Magnet roll
33 Bias power source
34 Cylindrical electrode

Although embodiments of the present invention have been described and illustrated in detail, the disclosed embodiments are made for purposes of illustration and example only and not limitation. The scope of the present invention should be interpreted by terms of the appended claims.

What is claimed is:

1. A resin, comprising a constitutional unit represented by a general formula (1) below: 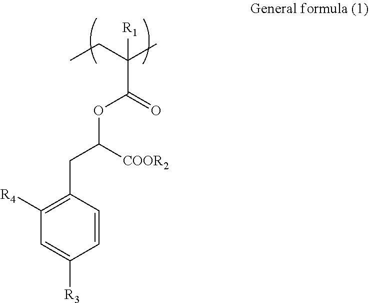
in the general formula (1), R₁ represents a hydrogen atom or a methyl group, R₂ represents a hydrogen atom or an alkyl group having 1 to 4 carbon atoms, and R₃ and R₄ each independently represent a hydrogen atom or an alkoxy group having 1 to 4 carbons.

2. The resin according to claim 1, wherein
R₂ in the general formula (1) is a methyl group, and R₃ and R₄ are each a hydrogen atom.

3. The resin according to claim 1, wherein
the resin is a copolymer of a first polymerizable monomer having a structure represented by a general formula (2) below and a second polymerizable monomer copolymerizable with the first polymerizable monomer: 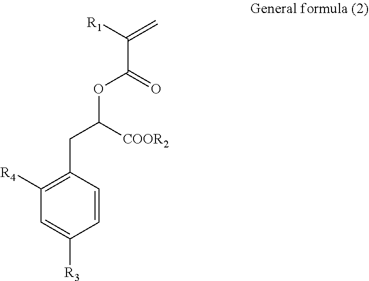
in the general formula (2), R₁ represents a hydrogen atom or a methyl group, R₂ represents a hydrogen atom or an alkyl group having 1 to 4 carbon atoms, and R₃ and R₄ each independently represent a hydrogen atom or an alkoxy group having 1 to 4 carbons.

4. The resin according to claim 3, wherein
a content of a constitutional unit derived from the first polymerizable monomer is 10% by mass to 40% by mass based on all of constitutional units constituting the resin.

5. The resin according to claim 3, wherein
the second polymerizable monomer includes at least one monomer selected from the group consisting of styrenes, acrylic acid, methacrylic acid, acrylic acid esters, and methacrylic acid esters.

6. The resin according to claim 5, wherein
the second polymerizable monomer includes at least one monomer selected from the group consisting of styrene, acrylic acid, n-butyl acrylate, iso-butyl acrylate, 2-ethylhexyl acrylate, methacrylic acid, n-butyl methacrylate, iso-butyl methacrylate, and 2-ethylhexyl methacrylate.

7. A resin composition, comprising the resin according to claim 1.

8. A printed image, comprising the resin according to claim 1.

9. An electrostatic charge image developing toner, comprising the resin according to claim 1.

10. A method for producing the electrostatic charge image developing toner according to claim 9, the method comprising:
providing a resin including a constitutional unit represented by a general formula (1) below: 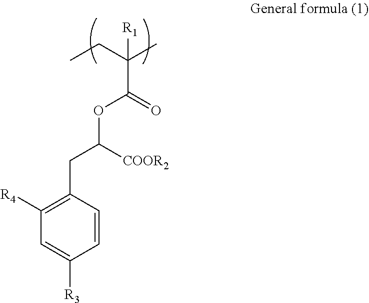
in the general formula (1), R₁ represents a hydrogen atom or a methyl group, R₂ represents a hydrogen atom or an alkyl group having 1 to 4 carbon atoms, and R₃ and R₄ each independently represent a hydrogen atom or an alkoxy group having 1 to 4 carbons;
preparing, from the resin, a dispersion liquid in which toner binder particles are dispersed; and
aggregating the toner binder particles in the dispersion liquid to fuse the toner binder particles together.

11. The method according to claim 10, wherein
the providing of the resin including the constitutional unit represented by the general formula (1) includes polymerizing a first polymerizable monomer having a structure represented by a general formula (2) below: 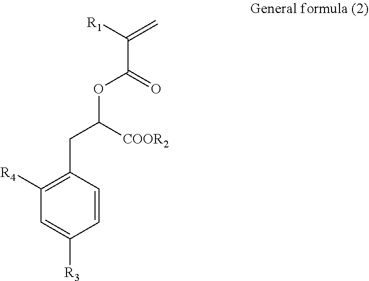
in general formula (2), R₁ represents a hydrogen atom or a methyl group, R₂ represents a hydrogen atom or an alkyl group having 1 to 4 carbon atoms, and R₃ and R₄ each independently represent a hydrogen atom or an alkoxy group having 1 to 4 carbons.
